(19) United States
(12) Patent Application Publication
(10) Pub. No.: US 2005/0231466 A1
(43) Pub. Date: Oct. 20, 2005

(54) Pointing device

(75) Inventor: Yukio Tada, Iwata-shi (JP)

Correspondence Address: PILLSBURY WINTHROP SHAW PITTMAN LLP, 725 S. FIGUEROA STREET, SUITE 2800, LOS ANGELES, CA, 90017, US

(73) Assignee: Yamaha Corporation, Hamamatsu-shi (JP)

(21) Appl. No.: 10/925,500

(22) Filed: Aug. 25, 2004

(30) Foreign Application Priority Data
Aug. 26, 2003 (JP) 2003-301521

(51) Int. Cl. G09G 5/00

(52) U.S. Cl. 345/156

(57) ABSTRACT

A sensing encoder fitted to a jog dial senses a rotation direction and a rotation amount of a dial and supplies the sensed result to a controller as operation information. A pointer moving unit, when receives the operation information, decides a position of the pointer based on the operation information and sends a moving instruction to a display device. At the same time, the pointer moving unit reads a value of the data pointed by the moved pointer from a hard disk, and then supplies this value to a vibration controlling unit. The vibration controlling unit controls a vibration generated by a vibration generating actuator in response to the value of the data that are received from the pointer moving unit.

### BACKGROUND OF THE INVENTION

The present invention relates to a pointing device used to move a pointer displayed on a display device.

As the operating device used to move a position of the pointer that is being displayed on the display device such as a display, various operating devices such as mouse, slider, jog dial, touch panel, and so on are employed. For example, when the computer in which the mouse is used as the operating device is utilized, the user moves the position of the pointer to a desired position by operating the mouse while gazing at the pointer displayed on the display device.

In this manner, in order to move the position of the pointer displayed on the display device to a desired position by using the operating device, such as mouse, the user has to operate the operating device while looking carefully at the display screen (an operation of moving the pointer is referred to as a “pointing operation” hereinafter). In this case, there existed such a problem that, if such pointing operation is executed continuously for a long time, symptoms such as nausea, giddiness, and the like appear because the user overworks his or her eyes excessively.

In such background, the technology to feed back the vibration by providing the vibration to respective operating devices was proposed. For example, JP-A-11-338629 discloses the technology to apply a predetermined vibration to the operating device that moves the pointer when the pointer displayed on a screen arrives at the particular position. JP-A-2001-222379 discloses the technology to feed back to the user by the vibration the information indicating to what extent the pointer in operation is away from a target position. According to these technologies, since the user can check the position of the pointer via not only the sense of sight but also the sense of touch, a burden on the eye imposed by the pointing operation can be reduced.

Certainly, according to the above related arts, the user can move the pointer to the particular position while not gazing steadily at the pointer so much. However, it is different in response to the contents of the data pointed by the pointer, etc. to decide what operation should be executed at that position. In other words, although the user can move the pointer to the particular position, such user must still gaze at the contents of the data pointed by the pointer to decide what operation should be executed at that position. In the end, there existed such a problem that the above related arts do not contribute to the large reduction in the burden on the eye imposed by the pointing operation.

### SUMMARY OF THE INVENTION

The present invention has been made in view of the above-mentioned circumstances, and it is an object of the present invention to provide a pointing device capable of reducing largely a burden on the eye imposed by the pointing operation.

In order to solve the aforesaid object, the invention is characterized by having the following arrangement.
(1) A pointing device comprising:
   a storage that stores values of data to be displayed on a display device;
   an operating device that is operated by a user to move a pointer that points to a value of the data;
   a contact portion with which a fingertip of the user comes into contact; and
   a controller that controls a touch state between the contact portion and the fingertip of the user based on the value of the data so that the user perceives tactile sensation of the contact portion via the fingertip according to the value of the data.
(2) The pointing device according to (1), wherein the contact portion is formed as a part of the operating device.
(3) The pointing device according to (1), wherein the operating device is one of a jog dial and a slider.
(4) The pointing device according to (1), wherein
   the data is a time-series wave signal representing an amplitude value, and
   the operating device moves the pointer in a time-series direction of the wave signal.
(5) The pointing device according to (1) further comprising a vibration applying unit that applies a vibration to the contact portion,
   wherein the controller controls the vibration so that the vibration applying unit applies to the contact portion in response to the value of the data pointed by the pointer.
(6) The pointing device according to (5), wherein the controllerchanges at least any one of parameters of a pattern and a magnitude of the vibration that the vibration applying unit applies to the contact portion, in response to the value of the data.
(7) The pointing device according to (1) further comprising a resistance applying unit for applying an operating resistance to the operating device,
   wherein the controller controls the operating resistance that the resistance applying unit applies to the operating device, in response to the value of the data pointed by the pointer.
(8) The pointing device according to (1), further comprising:
   a changing switch that switches a moving distance of the pointer per a unit amount of operation of the operating device; and
   a pointer moving unit that moves the pointer in response to the amount of operation of the operating device and the moving distance indicated by the changing switch.
(9) A pointing device comprising:
   a storage that stores respective values of data to be displayed on a display device;
   a marker attaching unit that attaches a marker to a value of the data in compliance with a marker setting instruction;
   an operating device that is operated by a user to move a pointer that points to the value of the data;
   a contact portion with which a fingertip of the user comes into contact; and
   a controller that changes a touch state between the contact portion and the fingertip of the user based on the value of the data such that the user perceives tactile sensation of the contact portion via the fingertip when the pointer points to the value of the data to which the marker attaching unit attaches the marker.
(10) The pointing device according to (9), wherein the contact portion is formed as a part of the operating device.
(11) The pointing device according to (9), wherein the operating device is one of a jog dial and a slider.
(12) The pointing device according to (9) further comprising a vibration applying unit that applies a vibration to the contact portion,
   wherein the controller controls the vibration so that the vibration applying unit applies to the contact portion when the pointer points to the value of the data to which the marker is attached by the marker attaching unit.
(13) The pointing device according to (12), wherein the controller changes at least any one of parameters of a pattern and a magnitude of the vibration that the vibration applying unit applies to the contact portion, in response to the value of the data.
(14) The pointing device according to (9) further comprising a resistance applying unit for applying an operating resistance to the operating device,
   wherein the controller controls the operating resistance that the resistance applying unit applies to the operating device when the pointer points to the value of the data to which the marker is attached by the marker attaching unit.

As described above, according to the present invention, a burden on the eye imposed by the pointing operation can be reduced largely.

### BRIEF DESCRIPTION OF THE DRAWINGS

FIG. 1 is a view showing a configuration of an audio editing system according to the present embodiment.

FIG. 2 is a view showing an example of a screen of a display device according to the same embodiment.

FIG. 3 is a view showing an appearance configuration of a pointing device according to the same embodiment.

FIG. 4 is a view showing a configuration of a jog dial according to the same embodiment.

FIG. 5 is a view showing a configuration of a slider according to the same embodiment.

FIG. 6 is a view explaining an operation taken to move a pointer according to the same embodiment.

FIG. 7 is a view exemplifying musical sound waveform data stored in a hard disk according to the same embodiment.

FIG. 8 is a view exemplifying a screen of a display device according to the same embodiment.

FIG. 9 is a view exemplifying a vibration management table according to the same embodiment.

FIG. 10 is a view explaining an operation taken when a pointer according to a modification 2 is moved.

FIG. 11 is a view exemplifying musical sound waveform data stored in a hard disk according to the same modification.

FIG. 12 is a view explaining an operation taken when a pointer according to a modification 3 is moved.

FIG. 13 is a view exemplifying an operating resistance management table according to the same modification.

### DETAILED DESCRIPTION OF PREFERRED EMBODIMENTS

Embodiments according to the present invention will be explained with reference to the drawings hereinafter.

A. Present Embodiment

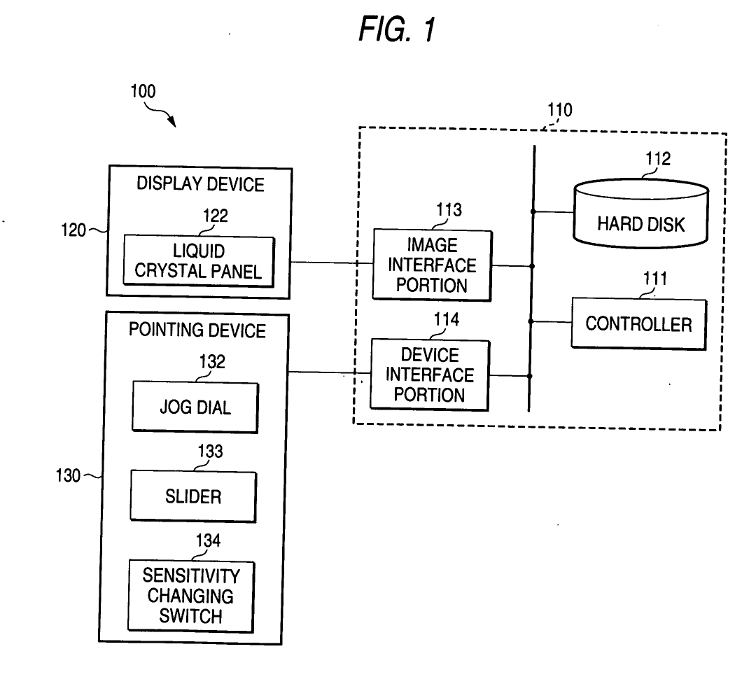

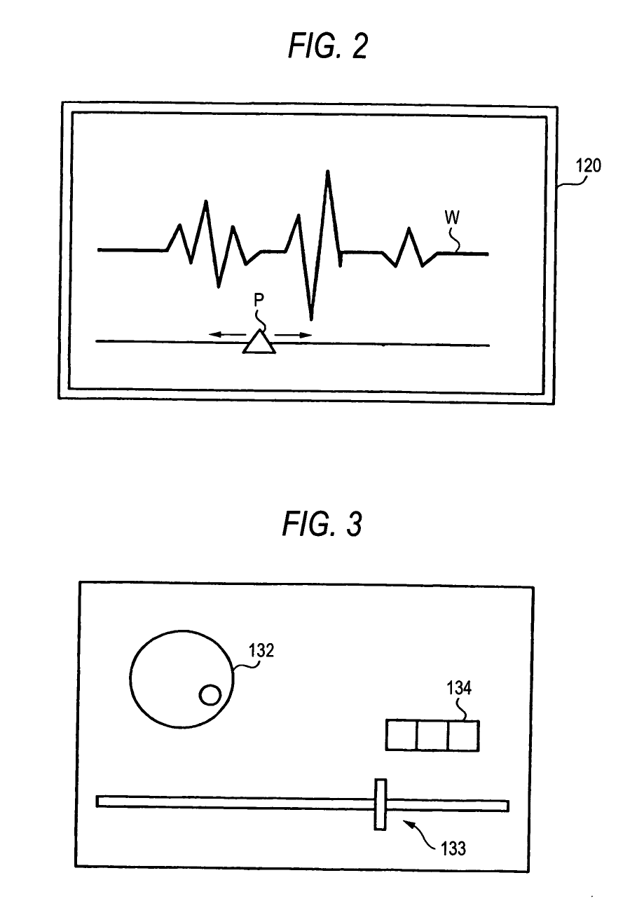

FIG. 1 is a view showing a configuration of an audio editing system 100 according to the present embodiment. The audio editing system 100 comprises a main unit 110 for collectively controlling respective portions of the audio editing system 100, a display device 120 (see FIG. 2) for displaying a musical sound waveform W, a pointer P, etc. in accordance with respective data supplied from the main unit 110, etc., a pointing device 130 (see FIG. 3) for moving the pointer P displayed on the display device 120, and a musical sound generating unit (not shown) for generating the musical sound based on musical sound waveform data corresponding to the musical sound waveform W.

As well known, upon editing the musical sound waveform, the designation of a particular point of the musical sound waveform (that is, finding the beginning or the particular point of the musical sound waveform) is needed to cut out the waveform, or the like. In order to execute the designating process (finding process), the user must execute the pointing operation by using the pointing device. In this case, it is the audio editing system 100 according to the present embodiment that can reduce a burden on the eye imposed by such operation.

<Main Unit 110>

A controller 111 is composed of CPU, ROM, RAM, and others. The controller 111 controls respective portions of the audio editing system 100 based on various control programs stored in the ROM, and also controls the vibration that is fed to a jog dial 132 and/or a slider 133 in response to operation information supplied from the pointing device 130 (the details will be described later). A hard disk (storage) 112 stores musical sound waveform data used to display the musical sound waveform W on the display device 120, pointer image information used to display the pointer P on the display device 120, etc. therein. An image interface portion 113 is an interface that transmits the musical sound waveform data, the pointer image information, etc. read by the controller 111 to the display device 120. A device interface portion 114 is an interface that transmits/receives operation information, etc. of the jog dial 132 and the slider 133 to/from the pointing device 130.

<Display Device 120>

The display device 120 includes a liquid crystal panel 122. The display device 120 receives the musical sound waveform data and the pointer image information transmitted from the controller 111, and displays the corresponding musical sound waveform W and the corresponding pointer P on the liquid crystal panel 122 based on respective information, etc.

<Pointing Device 130>

The pointing device 130 includes various operation switches and operation buttons (not shown), and also includes the jog dial (operating device) 132 for varying a position of the pointer P, etc., the slider (operating device) 133, a sensitivity changing switch 134, and so forth. The sensitivity changing switch 134 is a switch to switch a moving distance of the pointer P per a unit operation amount of the jog dial 132 and the slider 133 (i.e., sensitivity). The user switches a moving distance of the pointer P (the pointer P is put forward by 1 second, 10 second, or the like) by operating appropriately the sensitivity changing switch 134 when the jog dial 132 is made one rotation or the slider 133 is moved by 1 cm, for example. When the user switches the sensitivity of the jog dial 132 and the slider 133 in this manner, such user can switch whether the pointer P should be moved roughly or moved bit by bit by the same operation amount.

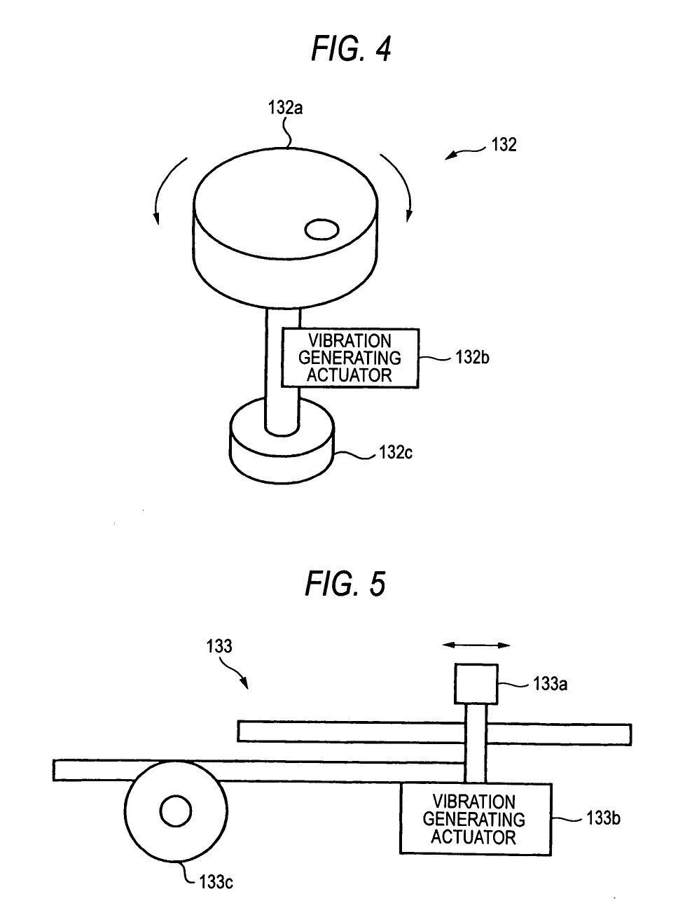

Here, FIG. 4 is a view showing a configuration of the jog dial 132, and FIG. 5 is a view showing a configuration of the slider 133. As shown in FIG. 4, the jog dial 132 has a dial 132a and a strut extended from an almost center of the dial 132a. A vibration generating actuator (vibration applying unit) 132b is provided to the intermediate portion of this strut, while a sensing encoder 132c for sensing operated states (rotation direction, rotation amount, etc.) of the dial 132a is provided to an end portion of the strut. On the other hand, as shown in FIG. 5, the slider 133 has an operating notch 133a and a strut extended from an almost center of the operating notch 133a. A vibration generating actuator (vibration applying unit) 133b is provided to an end portion of the strut, while a sensing encoder (operated-state sensor) 133c for sensing operated states (operation direction, rotation amount, etc.) of the operating notch 133a is provided to a connecting member fitted to the strut.

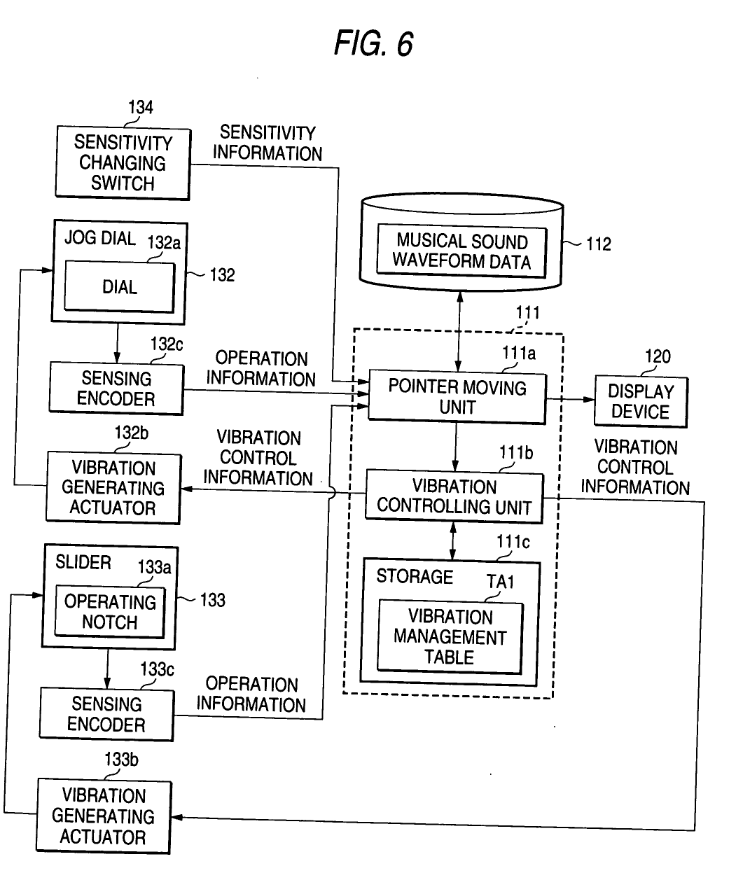

The user moves the pointer P up to a desired position by turning clockwise or anticlockwise the dial 132a of the jog dial 132 (see both arrows shown in FIG. 4) or moving leftward or rightward the operating notch 133a of the slider 133 (see a two-headed arrow shown in FIG. 5). Here, FIG. 6 is a view explaining an operation taken to move the pointer P. In this case, in the following description, suppose the case the user turns the dial 132a of the jog dial 132 to move the pointer P. First, the user operates the sensitivity changing switch 134 to switch the sensitivity such that, for example, the pointer P is moved forward by 1 second when the jog dial 132 is made one rotation. When such operation is made, sensitivity information to the effect that the pointer P is put forward by 1 second when the jog dial 132 is made one rotation is supplied from the sensitivity changing switch 134 to a pointer moving unit 111a of the controller 111. In this case, unless the sensitivity changing switch 134 is operated by the user, standard sensitivity information (e.g., information to the effect that the pointer P is put forward by 10 second when the jog dial 132 is made one rotation, or the like) stored in a memory (not shown) is supplied to the pointer moving unit 111a, otherwise the sensitivity information supplied to the pointer moving unit 111a before the last time is succeeded to as it is.

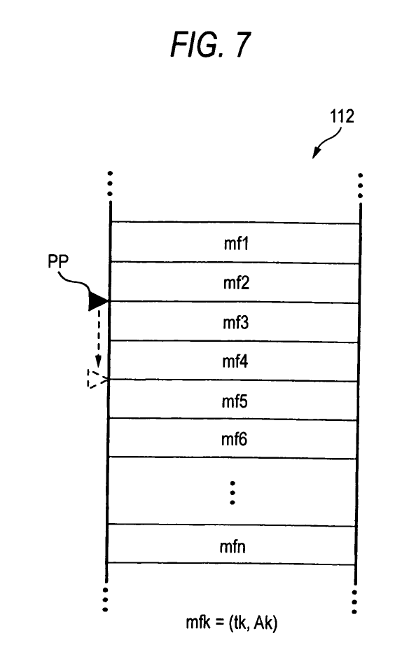

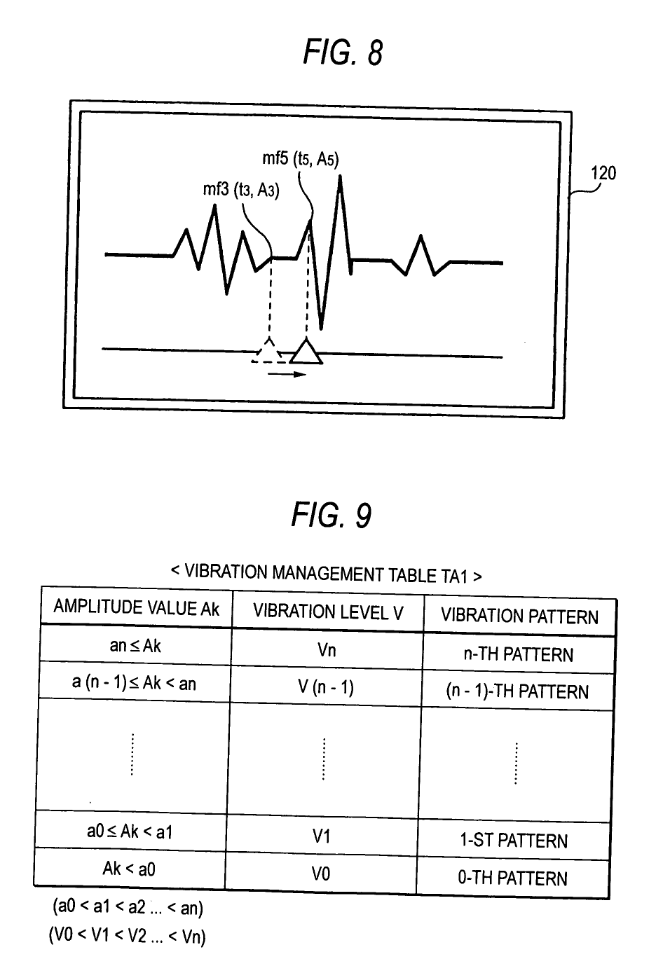

Then, the user turns the dial 132a of the jog dial 132 in a predetermined direction by a predetermined amount. The sensing encoder 132c senses the rotation direction, the rotation amount, etc. of the dial 132a, and supplies the sensed result to the controller 111 as the operation information. When the pointer moving unit 111a of the controller 111 receives the sensitivity information and the operation information, such pointer moving unit refers to the musical sound waveform data stored in the hard disk 112 to decide to which position of the musical sound waveform data the pointer P should be moved. FIG. 7 is a view exemplifying musical sound waveform data mfk (1≦k≦n) stored in the hard disk 112. As shown in FIG. 7, the musical sound waveform data mfk representing a pronouncing position tk and an amplitude value Ak are stored in time-series order in the hard disk 112. Here, for example, when the pointer P at the concerned point of time points represents the musical sound waveform data mf3 (see a position PP shown in FIG. 7), the pointer moving unit 111a decides based on received operation information and sensitivity information that the pointer P should be moved to a position of the musical sound waveform data mf5, and then sends the instruction indicating that the position of the pointer P should be moved to the position of the musical sound waveform data mf5 to the display device 120. As a result, as shown in FIG. 8, a screen in which the pointer P points to the musical sound waveform data mf5 is displayed on the liquid crystal panel 122 of the display device 120.

The pointer moving unit 111a sends the instruction to the effect that the position of the pointer P should be moved to the position of the musical sound waveform data mf5, as described above, to the display device 120. At the same time, the pointer moving unit 111a reads a value of the data pointed by the moved pointer P, i.e., the musical sound waveform data mfk (here, the musical sound waveform data mf5) from the hard disk 112, and supplies the value to a vibration controlling unit 111b. In this case, the musical sound waveform data that appears subsequently after one piece or plural pieces (e.g., the succeeding musical sound waveform data mf6, or the like) may be read in place of the musical sound waveform data mf5 that the pointer P points to immediately after its shift. The vibration controlling unit 111b, when receives the musical sound waveform data mf5 from the pointer moving unit 111a, decides a vibration level, a vibration pattern, etc. by referring to a vibration management table TA1 stored in a storage 111c. FIG. 9 is a view exemplifying the vibration management table TA1. An amplitude value Ak, a vibration level V representing a magnitude of the vibration, and a vibration pattern are registered in the vibration management table TA1 to be correlated mutually. In this case, in the present embodiment, as shown in FIG. 9, such a mode is shown that the vibration level V is enhanced (i.e., the vibration is increased) in proportion to the magnitude of the amplitude value Ak. But it may be varied appropriately how to define the relationship between the amplitude value Ak and the vibration level V and 6 the relationship between the amplitude value Ak and the vibration pattern. In addition to that both parameters of the vibration level and the vibration pattern can be identified, any one parameter (e.g., only the vibration level) may be identified. Now, the vibration controlling unit 111b, when identifies the vibration level (e.g., V5) and the vibration pattern (the 5-th pattern) based on an amplitude value A5 of the received musical sound waveform data mf5, sends the identified vibration level and the identified vibration pattern to the vibration generating actuator 132b as the vibration control information.

The vibration generating actuator 132b, when receives the vibration control information from the vibration controlling unit 111b, vibrates the jog dial 132 at the vibration level and the vibration pattern in compliance with the vibration control information. In this manner, in the present embodiment, the vibration applied to the jog dial 132 is controlled in response to the value of the data pointed by the pointer P. Therefore, the user can perceive the value of the data that the pointer P pointed at via the sense of touch without gazing at a screen displayed on the display device 120, and as a result a burden on the eye imposed by the pointing operation can be reduced largely. In this case, in the above example, the case where the user moves the pointer P by utilizing the jog dial 132 is explained. But the case where the user moves the pointer P by utilizing the slider 133 can be similarly explained. In other words, in the above example, if the dial 132a is replaced with the operating notch 133a, the vibration generating actuator 132b is replaced with the vibration generating actuator 133b, and the sensing encoder 132c is replaced with the sensing encoder 133c, the case where the user moves the pointer P by utilizing the slider 133 can be similarly explained. Therefore, further explanation will be omitted herein.

B. Modifications

<Modification 1>

In the present embodiment explained above, the case where the vibration is generated in response to the value of the data that the pointer P points to immediately after its shift when the pointer P is moved in response to the operation of the jog dial 132, or the like is explained. In this case, for example, the vibration may be generated in response to the value of the data that the pointer P points to at that point of time when the pointer P is not moved. According to such mode, the user can perceive the value of the data that the pointer P points to at that point of time by touching the jog dial 132, or the like with his or her fingers, i.e., without looking at carefully the display screen. In this case, in the present embodiment, the vibration level, the vibration pattern, and so forth are identified based on only the amplitude value Ak indicated in the musical sound waveform data mfk. But the vibration level, the vibration pattern, and so forth may be decided based on the musical sound generating position tk and the amplitude value Ak indicated in the musical sound waveform data mfk. The vibration level and the vibration pattern may be decided by using a vibration control algorithm used to identify the vibration level and the vibration pattern instead of the above vibration management table TA1.

<Modification 2>

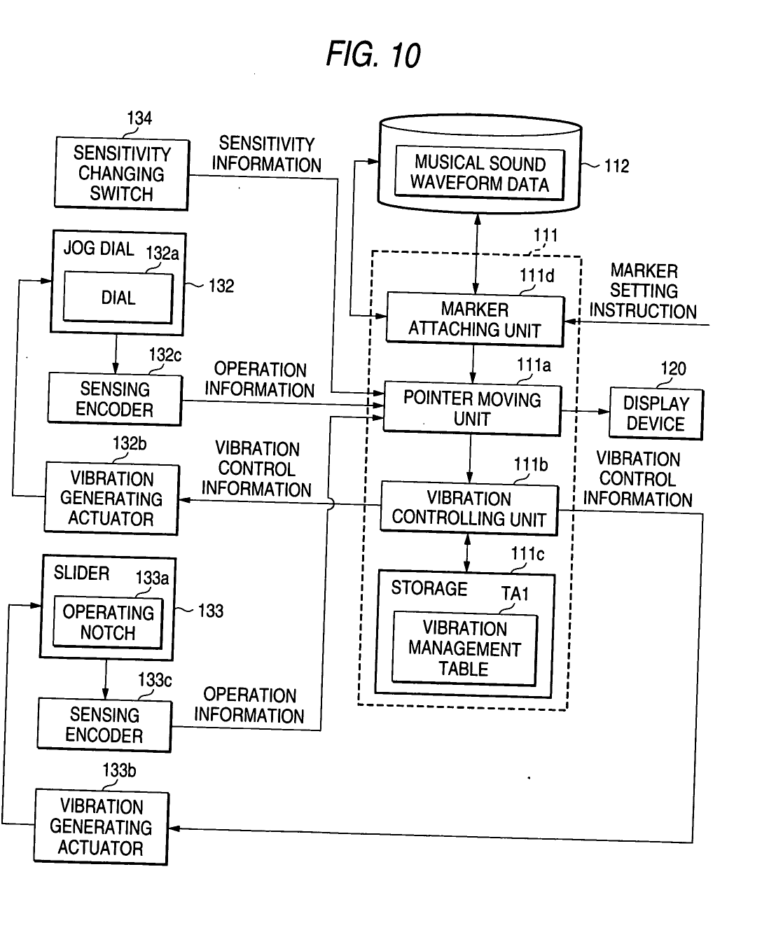

FIG. 10 is a view explaining an operation taken to move the pointer P according to a modification 2, which corresponds to above FIG. 6. In this case, in FIG. 10, the same reference symbols are affixed to portions corresponding to those in FIG. 6, and their detailed explanation will be omitted herein. Like the above embodiment, the case where the pointer P is moved by turning the dial 132a of the jog dial 132 is supposed in the present modification 2. A marker attaching unit 111d provided to the controller 111 attaches the marker to the corresponding musical sound waveform data mfk in accordance with the marker setting instruction input via an operation button, or the like (not shown) (or the marker setting instruction stored previously in a memory, or the like). Now, the instruction for attaching the marker to the musical sound waveform data mfk every ten second, i.e., the instruction for attaching the marker to the musical sound waveform data mfk acting as a pause of the phrase, and the like may be listed as the marker setting instruction. But it may be varied appropriately in response to the marker setting instruction, or the like to decide to which musical sound waveform data mfk the marker should be attached. Here, it may be determined based on whether or not a silent time is continued for a predetermined second or more, for example, to decide whether or not the musical sound waveform data mfk should act as the pause of the phrase

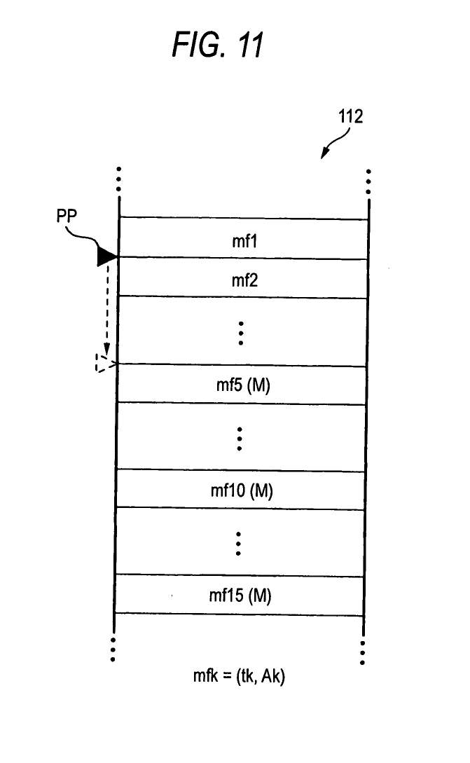

Then, FIG. 11 is a view exemplifying the musical sound waveform data mfk stored in the hard disk 112 according to the modification 2, which corresponds to above FIG. 7. A marker M is attached to the particular musical sound waveform data (e.g., the musical sound waveform data every 10 second) mfk, as shown in FIG. 11. Such marker M is attached by the marker attaching unit 111d. In the situation that such musical sound waveform data mfk are stored in the hard disk 112, when the pointer moving unit 111a receives the operation information, which indicates to move the position of the pointer P at this point of time (see the position PP shown in FIG. 11) to the position of the musical sound waveform data mfk to which the marker M is attached (the position of the musical sound waveform data mf5 in FIG. 11), from the sensing encoder 132c, the pointer moving unit 111a sends the instruction that indicates to move the position of the pointer P to the position of the musical sound waveform data mf5 to the display device 120. At the same time, the pointer moving unit 111a sends the instruction to the vibration controlling unit 111b to generate the vibration. The vibration controlling unit 111b generates the vibration control information to generate a predetermined vibration in compliance with such instruction, and sends this information to the vibration generating actuator 132b.

When the vibration generating actuator 132b receives the vibration control information from the vibration controlling unit 111b, it vibrates the jog dial 132 in accordance with the vibration control information. In this manner, in the present modification, the predetermined vibration is generated every time when the position of the pointer P arrives at the particular position to which the marker M is attached. Since the user who operates the jog dial 132 or the like can sense this vibration via the tip of the finger, such user can identify the position of the pointer P via the sense of touch without watching carefully the screen being displayed on the display device 120. In this case, in the present modification, the case where the predetermined vibration is generated every time when the position of the pointer P arrives at the particular position is explained. However, like the above embodiment, the vibration level, the vibration pattern, etc. may be varied in response to the value of the musical sound waveform data mfk in the particular position. In this case, since such mode can be explained in the same manner as the above embodiment, their explanation will be omitted herein.

<Modification 3>

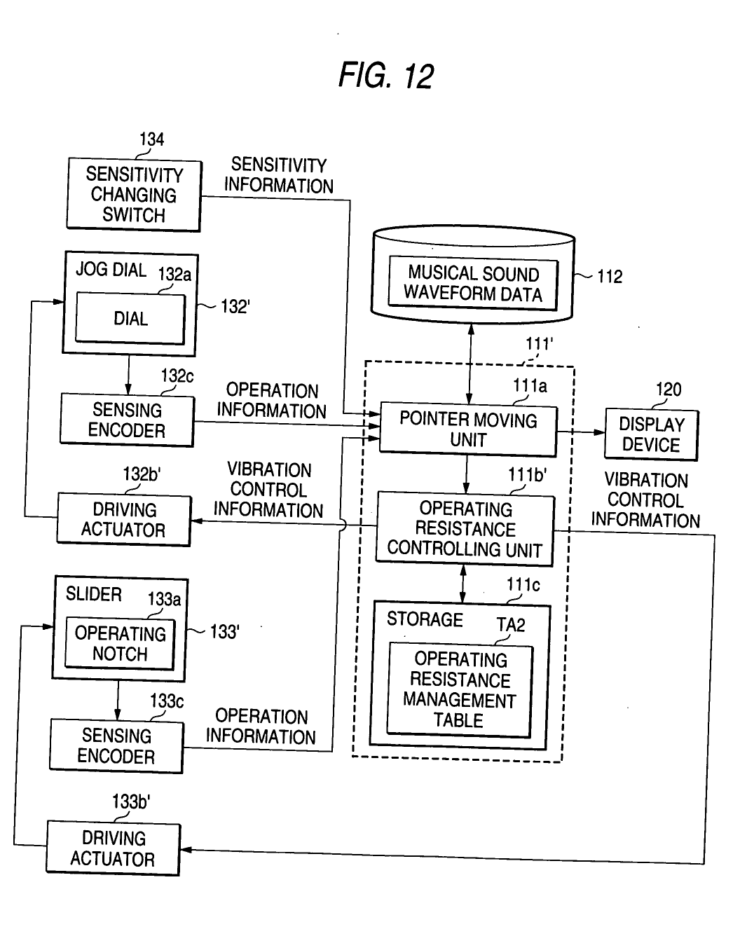

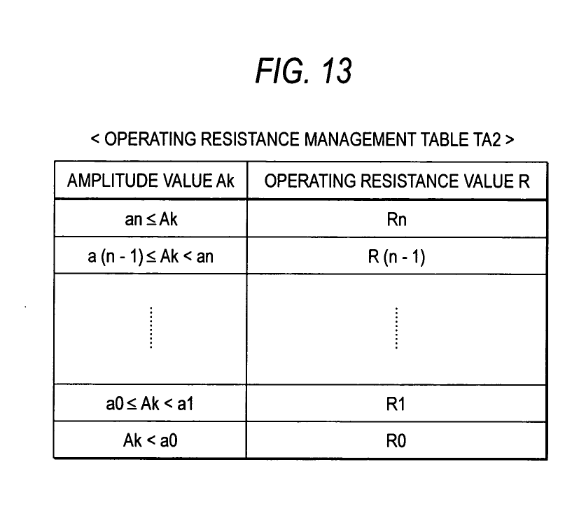

FIG. 12 is a view explaining an operation taken to move the pointer P according to a modification 3, which corresponds to the above FIG. 6. In FIG. 12, the same reference symbols are affixed to portions corresponding to those in FIG. 6, and their detailed explanation will be omitted herein. As apparent from the comparison between FIG. 6 and FIG. 12, driving actuators (resistance applying unit) 132b′, 133b′are provided to a jog dial 132′ and a slider 133′ in place of the vibration generating actuators 132b, 133b respectively, and an operating resistance controlling unit 111b′ is provided to a controller 111′ in place of the vibration controlling unit 111b. The operating resistance controlling unit 111b′ controls an operating resistance applied to the driving actuators 132b′, 133b′, based on the musical sound waveform data mfk supplied from the pointer moving unit 111a and an operating resistance management table TA2. Here, FIG. 13 is a view exemplifying the operating resistance management table TA2. Amplitude values Ak and operating resistance values R are registered in the operating resistance management table TA2 to be correlated mutually. In this case, in the modification 3, such a mode is exemplified that the operating resistance is increased in proportion to the magnitude of the amplitude value Ak. But the operating resistance may be decreased in inverse proportion to the magnitude of the amplitude value Ak, for example, and it can be varied appropriately how to define the relationship between the amplitude value Ak and the operating resistance value R.

When the operating resistance controlling unit 111b′ decides the operating resistance value R by referring to the operating resistance management table TA2, it supplies the decided operating resistance value R to the driving actuators 132b′, 133b′ as the operating resistance control information respectively. The driving actuators 132b′, 133b′ apply the operating resistance to the jog dial 132′ and the slider 133′, respectively, in pursuance of the operating resistance control information supplied from the operating resistance controlling unit 111b′, whereby the mobility (easy-move property) of the jog dial 132′ and the slider 133′ is controlled. More particularly, respective motions of the jog dial 132′ and the slider 133′ become tight in the area in which the applied operating resistance becomes large (i.e., the sound becomes large) whereas respective motions of the jog dial 132′ and the slider 133′ become smooth in the area in which the applied operating resistance becomes small (i.e., the sound becomes small). The user can catch the value of the data pointed by the pointer P by perceiving change of the operating resistance applied to the jog dial 132′ and the like, whereby a burden on the eye imposed by the pointing operation can be reduced. As described above, the user may be informed of the value of the data pointed by the pointer P by changing not the vibration but the operating resistance. In this case, the modification 1 or the modification 2 described above may be applied to the present modification. When the modification 2 is applied to the present modification, a predetermined operating resistance is generated every time when the jog dial 132′ and the like arrive at their particular positions and thus the motions of the jog dial 132′ and the like are made tight (or smooth). Therefore, the user can identify the position of the pointer P via the sense of touch not to gaze steadily at the screen displayed on the display device 120.

<Modification 4>

In the present embodiment and respective modifications, the case where the vibration or the operating resistance is fed back with respect to one musical sound waveform W (see FIG. 2) as the object is explained. In this case, the vibration or the operating resistance may be fed back with respect to plural musical sound waveforms as the object. In detail, a value of the musical sound waveform data of a first musical sound waveform pointed by a first pointer, a value of the musical sound waveform data of a second musical sound waveform pointed by a second pointer, . . . , and a value of the musical sound waveform data of an n-th musical sound waveform pointed by an n-th pointer may be summed up, and then the vibration or the operating resistance to be fed back may be controlled based on this summed value, etc. The present invention can be applied similarly to not only the musical sound waveform but also time-series data such as the audio waveform that is synchronized with the video, the speech waveform, the brightness signal picked out from the video signal, and others. In addition, it should not be interpreted that the present invention is limited to the time-series data, and the present invention can be applied to all types of data in which a data value exists at a point pointed by the pointer P.

<Modification 5>

In the present embodiment and respective modifications, the jog dial 132 and the slider 133 are exemplified as the operating device constituting the pointing device 130. All operating devices such as the general-purpose mouse, the touch panel, etc. can be applied. In this case, in the present embodiment and respective modifications, the pointing device that is incorporated into the audio editing system 100 is explained as the example. But it is of course that the present invention can be applied to all equipments having the pointing device.

<Modification 6>

In the present embodiment and respective modifications, the vibration generating actuators 132b, 133b for applying the vibration to the operating device, and the driving actuators 132b′, 133b′ for applying the operating resistance to the operating device are exemplified as the device for providing the touch to the fingertip of the user. In this case, for example, a power generating unit for providing a weak electric current to the operating device may be provided. In case the power generating unit is provided in this way as the device for providing the touch to the fingertip of the user, a power-generation controlling means (touch controller) for controlling a touch state between a contact portion (portion with which the fingertip of the user who operates the operating device comes into contact) and the fingertip of the user based on the data value may be provided to the controller 111 in such a manner that the tactile sensation of the contact portion that the user perceives via his or her fingertip is differentiated based on the data value pointed by the pointer P.

1. A pointing device comprising:
a storage that stores values of data to be displayed on a display device;
an operating device that is operated by a user to move a pointer that is displayed on the display device and points to a value of the data;
a contact portion with which a fingertip of the user comes into contact; and
a controller that controls a touch state between the contact portion and the fingertip of the user based on the value of the data so that the user perceives tactile sensation of the contact portion via the fingertip according to the value of the data.

2. The pointing device according to claim 1, wherein the contact portion is formed as a part of the operating device.

3. The pointing device according to claim 1, wherein the operating device is one of a jog dial and a slider.

4. The pointing device according to claim 1, wherein
the data is a time-series wave signal representing an amplitude value, and
the operating device moves the pointer in a time-series direction of the wave signal.

5. The pointing device according to claim 1 further comprising a vibration applying unit that applies a vibration to the contact portion,
wherein the controller controls the vibration so that the vibration applying unit applies to the contact portion in response to the value of the data pointed by the pointer.

6. The pointing device according to claim 5, wherein the controllerchanges at least any one of parameters of a pattern and a magnitude of the vibration that the vibration applying unit applies to the contact portion, in response to the value of the data.

7. The pointing device according to claim 1 further comprising a resistance applying unit for applying an operating resistance to the operating device,
wherein the controller controls the operating resistance that the resistance applying unit applies to the operating device, in response to the value of the data pointed by the pointer.

8. The pointing device according to claim 1, further comprising:
a changing switch that switches a moving distance of the pointer per a unit amount of operation of the operating device; and
a pointer moving unit that moves the pointer in response to the amount of operation of the operating device and the moving distance indicated by the changing switch.

9. A pointing device comprising:
a storage that stores respective values of data to be displayed on a display device;
a marker attaching unit that attaches a marker to a value of the data in compliance with a marker setting instruction;
an operating device that is operated by a user to move a pointer that is displayed on the display device and points to the value of the data;
a contact portion with which a fingertip of the user comes into contact; and
a controller that changes a touch state between the contact portion and the fingertip of the user based on the value of the data such that the user perceives tactile sensation of the contact portion via the fingertip when the pointer points to the value of the data to which the marker attaching unit attaches the marker.

10. The pointing device according to claim 9, wherein the contact portion is formed as a part of the operating device.

11. The pointing device according to claim 9, wherein the operating device is one of a jog dial and a slider.

12. The pointing device according to claim 9 further comprising a vibration applying unit that applies a vibration to the contact portion,
wherein the controller controls the vibration so that the vibration applying unit applies to the contact portion when the pointer points to the value of the data to which the marker is attached by the marker attaching unit.

13. The pointing device according to claim 12, wherein the controller changes at least any one of parameters of a pattern and a magnitude of the vibration that the vibration applying unit applies to the contact portion, in response to the value of the data.

14. The pointing device according to claim 9 further comprising a resistance applying unit for applying an operating resistance to the operating device,
wherein the controller controls the operating resistance that the resistance applying unit applies to the operating device when the pointer points to the value of the data to which the marker is attached by the marker attaching unit.
